(19) United States
(12) Patent Application Publication
(10) Pub. No.: US 2013/0257153 A1
(43) Pub. Date: Oct. 3, 2013

(54) POWER DISTRIBUTION SYSTEM AND METHOD OF DISTRIBUTING POWER

(71) Applicants: Michael Krenz, Roscoe, IL (US); Carl A. Wagner, Beloit, WI (US); Jeffrey T. Wavering, Rockford, IL (US); Michael William Foster, Rockford, IL (US); Norbert J. Simper, Bissingen (DE); Josef Maier, Munningen (DE); Rainer J. Seidel, Tussenhausen (DE)

(72) Inventors: Michael Krenz, Roscoe, IL (US); Carl A. Wagner, Beloit, WI (US); Jeffrey T. Wavering, Rockford, IL (US); Michael William Foster, Rockford, IL (US); Norbert J. Simper, Bissingen (DE); Josef Maier, Munningen (DE); Rainer J. Seidel, Tussenhausen (DE)

(73) Assignee: HAMILTON SUNDSTRAND CORPORATION, Windsor Locks, CT (US)

(21) Appl. No.: 13/433,925

(22) Filed: Mar. 29, 2012

(51) Int. Cl. H02J 3/00

(52) U.S. Cl. 307/29; 307/18

(57) ABSTRACT

A power distribution system includes a plurality of power sources for generating power. Also included is at least one power routing element in operable communication with each of the plurality of power sources, the at least one power routing element being configured to selectively receive power from the plurality of power sources. Further included is at least one load in operable communication with the at least one power routing element, wherein the at least one power routing element controllably determines which of the plurality of power sources to selectively receive power from.

### BACKGROUND OF THE INVENTION

The present invention relates to power distribution systems, and more particularly to power distribution systems having a plurality of power sources and methods of distributing power within such systems.

Power distribution systems typically involve three general stages, including power generation, primary distribution and secondary distribution. Power generation includes a switch that protects a generator which functions in the power generation stage of the power distribution system. Primary distribution routes power from one or more power sources to various bus bars (e.g., left, right, essential, battery, etc.), and potentially includes cross ties between the bus bars to form a matrix of distribution between the power sources and the bus bars. Secondary distribution is typically tied between a single bus bar and to many individual loads. Therefore, each secondary distribution element is tied to only one bus and is reliant upon that bus being powered to function.

### BRIEF DESCRIPTION OF THE INVENTION

According to one embodiment, a power distribution system includes a plurality of power sources for generating power. Also included is at least one power routing element in operable communication with each of the plurality of power sources, the at least one power routing element being configured to selectively receive power from the plurality of power sources. Further included is at least one load in operable communication with the at least one power routing element, wherein the at least one power routing element controllably determines which of the plurality of power sources to selectively receive power from.

According to another embodiment, a method of distributing power is provided. The method includes generating power with a plurality of power sources. Also included is distributing power from at least one of the plurality of power sources to at least one power routing element that is in operable communication with each of the plurality of power sources. Further included is controllably determining which of the plurality of power sources is to supply power to the at least one power routing element. Yet further included is powering at least one load with at least one of the plurality of power sources through the at least one power routing element.

According to yet another embodiment, a method of distributing power is provided. The method includes generating power with a first power source and a second power source. Also included is distributing power from the first power source to a power routing element. Further included is powering at least one load via the power routing element. Yet further included is switching the power received by the power routing element from the first power source to the second power source.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of an exemplary power distribution system having a plurality of power sources;

FIG. 2 is a solid state switch of the exemplary power distribution system in operable communication with the plurality of power sources; and

FIG. 3 is a flow diagram illustrating a method of distributing power with a system having the plurality of power sources according to an embodiment.

### DETAILED DESCRIPTION OF THE INVENTION

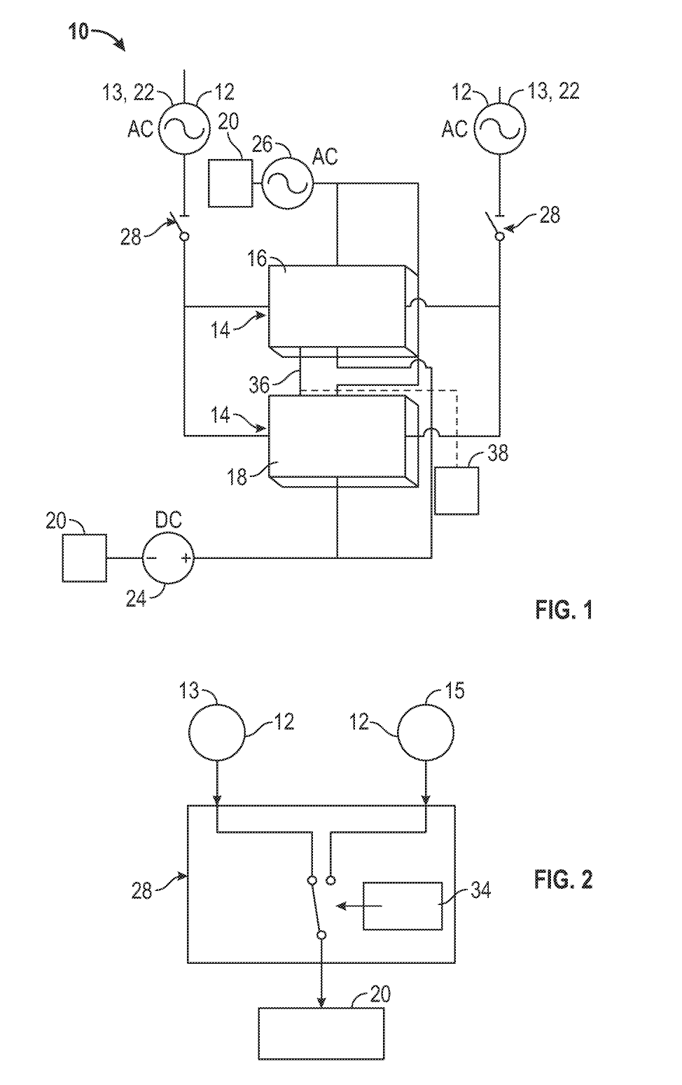

Referring to FIG. 1, a power distribution system is schematically illustrated with the reference numeral 10. The power distribution system 10 may function within a number of applications, including but not limited to vehicles, such as an aircraft, for example. Although discussed with reference to a vehicle, such as an aircraft, it is to be appreciated that the power distribution system 10 may be employed in conjunction with any application that requires power to be distributed from a plurality of sources to a variety of loads.

The power distribution system 10 includes at least one, but typically a plurality of power sources 12, and in the illustrated embodiment may be referred to as a left source 13 and a right source 15. The plurality of power sources 12 are capable of generating and supplying power within the power distribution system 10. Each of the plurality of power sources 12 is in operable communication with at least one, but typically a plurality of, power routing elements 14, such as a first power block 16 and a second power block 18, via at least one solid state switch 28. The term “power block” conceptually refers to hardware structure that functionally monitors and protects at least one load 20, but typically a plurality of load circuits. Nominally, this may include solid state power controllers (SSPCs), control logic, processing logic, internal communications busses, and power supplies to power various control elements. It may also include the devices necessary to convert the power from what is available at the input to the power block to what the various loads 20 require (e.g. AC to DC conversion). In the illustrated embodiment, each of the first power block 16 and the second power block 18 include a component, such as a rectifier, that converts an AC input power type 22 to a DC output power type 24, however, an AC output power type 26 may also be maintained for a load requiring such a power type. The exemplary components described above, with reference to the power block composition, are not an exhaustive list of potential components and functions that the power block may include, as other miscellaneous components or modules may be present to complement desired functionality. The first power block 16 and the second power block 18 may be operably tied by one or more communications bus 36. The power distribution system 10 also includes a controller 38 for receiving and processing a variety of information, as discussed below.

Referring to FIG. 2, each power routing element 14 comprises or is in operable communication with the at least one solid state switch 28, which may also be categorized as the power routing element 14 at a fundamental level. At least one of the plurality of power sources 12, such as the left source 13 and/or the right source 15, generates and supplies power to the at least one solid state switch 28 (FIG. 1), which then directs power to the at least one load 20. A control device 34 for the solid state switch 28 is generally illustrated, and in an exemplary embodiment is a power block, such as the first power block 16 or the second power block 18 described above.

Irrespective of the precise number of the plurality of power sources 12, the at least one power routing element 14 and the at least one load 20, each of the power routing elements 14 are in operable communication with each other via an element such as the previously-noted one or more communications bus 36 (FIG. 1). The communications bus 36 may communicate which of the plurality of power sources 12 are supplying power to a particular power routing element 14, as well as characteristics of the supplied power, such as the amount of current being drawn from each of the plurality of power sources 12. The communication of such information may be between each of the power routing elements 14 and/or a controller 38 (FIG. 1) that is configured to receive a variety of information and perform a variety of functions associated with the power distribution system 10. Such communication provides more efficient use of available power, with respect to the overall power distribution system 10.

The above-described power distribution system 10 provides the ability of a load 20 that is routed power by the first power block 16, for example, to receive power from more than one of the plurality of power sources 12, based on the ability of the first power block 16 to selectively determine which power source to supply power from. Such a configuration is particularly beneficial in a scenario where a power source is unavailable and rapid switching to a distinct power source is available. The at least one solid state switch 28 that is in communication, or integrated with the power routing element 14, such as a power block, is configured to measure current, rapidly switch and alter current limiting settings. Dynamic alteration of current limiting prevents overloading of a particular power source.

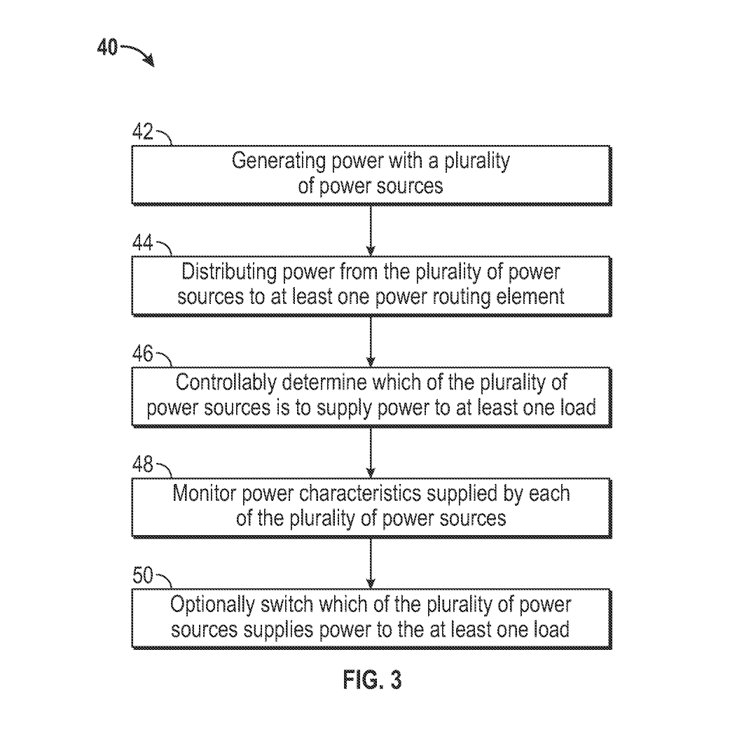

Referring to FIG. 3, a method of distributing power 40 based on the power distribution system 10 is also provided. The power distribution system 10 has been previously described and specific structural components need not be described in further detail. The method includes generating power with the plurality of power sources 42 and distributing such power to one or more loads via a power routing element 44, such as a power block. The power routing element is in operable communication with a plurality of power sources and is configured to controllably determine which of the plurality of power sources is to supply power 46 to the at least one load via the at least one power routing element. The determination of which of the plurality of power sources is to be drawn from is based on a variety of factors that take into account overall efficiency and availability of each of the plurality of power sources. Additionally, various power characteristics are monitored 48 and measured, such as the current drawn from each of the plurality of power sources. The current limit associated with trip logic of the power routing element, such as the power block, may be adjusted to prevent a particular power source from being overloaded. The solid state switch provides the capability to rapidly and reliably switch the power source from which power is being supplied 50 to the at least one load and is controlled, at least in part, by the power routing element, such as the first power block or second power block, which are in operable communication with each other to selectively determine which power source is to be drawn from.

Accordingly, a load powered by a power source is not reliant on availability or functionality of a single power source and the power distribution system is configured to selectively determine when and how much power to draw from a particular power source, which is enabled by the above-described solid state switches which are incorporated within or in communication with one or more power blocks.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A power distribution system comprising:
a plurality of power sources for generating power;
at least one power routing element in operable communication with each of the plurality of power sources, the at least one power routing element being configured to selectively receive power from the plurality of power sources; and
at least one load in operable communication with the at least one power routing element, wherein the at least one power routing element controllably determines which of the plurality of power sources to selectively receive power from.

2. The power distribution system of claim 1, further comprising a plurality of power routing elements that are in operable communication with each other.

3. The power distribution system of claim 2, wherein the at least one load is configured to receive power from each of the plurality of power routing elements.

4. The power distribution system of claim 1, wherein the at least one power routing element comprises a solid state switch configured to selectively determine which of the plurality of power sources to draw power from.

5. The power distribution system of claim 4, wherein the solid state switch is configured to switch between one of the plurality of power sources for providing power to the at least one load.

6. The power distribution system of claim 1, wherein the at least one power routing element comprises a power block.

7. The power distribution system of claim 6, wherein the power block comprises at least one of a solid state power controller (SSPC), a logic unit, an internal communications bus, and a power supply.

8. The power distribution system of claim 6, wherein the power block comprises a rectifier device for converting a power block input power type to a power block output power type.

9. The power distribution system of claim 8, wherein the power block input power type is alternating current (AC) and the power block output power type is direct current (DC).

10. A method of distributing power comprising:
generating power with a plurality of power sources;
distributing power from at least one of the plurality of power sources to at least one power routing element that is in operable communication with each of the plurality of power sources;
controllably determining which of the plurality of power sources is to supply power to the at least one power routing element; and
powering at least one load with at least one of the plurality of power sources through the at least one power routing element.

11. The method of claim 10, further comprising operably connecting a first power routing element to a second power routing element with at least one communication bus.

12. The method of claim 11, further comprising communicating a current amount being drawn from at least one of the plurality of power sources by the first power routing element via the at least one communication bus to the second power routing element.

13. The method of claim 10, wherein the at least one power routing element comprises a power block having at least one solid state switch.

14. The method of claim 13, further comprising measuring a current drawn by the power block from at least one of the plurality of power sources.

15. The method of claim 14, further comprising controlling the current limit for the current drawn by the power block.

16. The method of claim 13, further comprising switching between one the plurality of power sources for selectively distributing power.

17. A method of distributing power comprising:
generating power with a first power source and a second power source;
distributing power from the first power source to a power routing element;
powering at least one load via the power routing element; and
switching the power received by the power routing element from the first power source to the second power source.

18. The method of claim 17, wherein the power routing element comprises a solid state switch.

19. The method of claim 18, further comprising measuring and controlling a current drawn from at least one of the first power source and the second power source.
